(19) United States
(12) Patent Application Publication
(10) Pub. No.: US 2024/0401881 A1
(43) Pub. Date: Dec. 5, 2024

(54) APPARATUS AND METHOD FOR THERMAL PROCESSING

(71) Applicant: RENERGI PTY LTD, Yallingup (AU)

(72) Inventors: Chun-Zhu Li, Subiaco (AU); Li Dong, Subiaco (AU); Richard Gunawan, Subiaco (AU)

(21) Appl. No.: 18/696,937

(22) PCT Filed: Oct. 5, 2022
(86) PCT No.: PCT/AU2022/051190

§ 371 Date: Mar. 28, 2024

(30) Foreign Application Priority Data
Oct. 7, 2021 (AU) 2021903219

(51) Int. Cl. F27B 7/08; B02C 17/04; F27B 7/22; F27B 7/30

(52) U.S. Cl. CPC F27B 7/08; F27B 7/22; F27B 7/30; B02C 17/04; F27B 2007/2246; F27M 2003/14

(57) ABSTRACT

A thermal processing apparatus and a thermal processing method where the vessel with interconnected chambers in which the solid material is thermally processed is suspended in a heat exchange medium while it is rotated, which reduces the energy to rotate the vessel, increases heat transfer surface area, increases the turbulence of the heat exchange medium around the vessel and improves the movement of solid particles relative to each other and relative to the heat exchange surface. These features combine to increase the heat transfer rates within a compact vessel size.

### FIELD OF THE INVENTION

The present invention relates to an apparatus and a method for thermal processing, particularly the thermal processing of solid materials and more particularly the drying, torrefaction and pyrolysis of carbonaceous materials such as biomass, solid wastes and fossil fuels.

### BACKGROUND OF THE INVENTION

Many physical and chemical processes are either exothermic or endothermic-generally termed hereinafter as thermal processing, including heating and cooling. Heat needs to be supplied or removed.

Known means for supplying or removing heat from a material include
(a). direct means via contact or mixing, for example, passing a stream of hot flue gas or a stream of cold air through a bed of solid material to be thermally processed; and/or
(b). indirect means via heat transfer, for example, where heat from another source such as thermal oil is transferred to the material via a heat exchanger.

Despite many advantages, direct means are limited in many practical applications. This is because many processes cannot be carried out by allowing a solid material to contact or be exposed to air or another medium. For example, drying municipal solid wastes by passing through a hot stream of flue gas may spread pathogens and emit odorous compounds into the environment; contacting combustible solids with hot air may cause explosion; cooling down a hot solid product by blowing cold air may oxidise the product; oxygen in air may react with the solid material; and processes such as pyrolysis need to take place in the absence of sufficient air supply. In these types of applications, indirect heat supply or removal via an indirect means, for example a heat exchanger, would be desirable.

The economics of thermally processing a solid material via heat transfer largely depends on the creation of large heat transfer surface areas. In the applicant's earlier PCT International Patent Publication WO 2015089556, the content of which is herein incorporated by reference in its entirety, an apparatus for pyrolysing carbonaceous material is disclosed having a vessel with enhanced heat transfer surface area. However, the arrangement disclosed therein requires an energy intensive agitator to continuously stir and transfer the solid material to be thermally processed from the inlet to the outlet of a stationary vessel. The stirring action is necessary to create turbulence in the solid particle movement, which is in turn critically important to increase the rate of heat transfer to the solid particles. In addition to high energy consumption, the agitator also causes enhanced frictions between the solid material to be processed and the reactor walls, negatively impacting the life time of the equipment. Furthermore, an energy intensive pump is required to pump the heat exchange medium, especially liquid, at velocities sufficiently high to achieve fluid turbulence for high heat transfer rates.

In many existing thermal processing processes using apparatuses such as rotary kilns, the vessels holding the solid materials to be processed need to have thick walls in order to have sufficient strengths to accommodate the heavy weight of the solid materials to be processed. However, a thick wall tends to slow down the heat transfer rate across the walls. With relatively low heat transfer coefficients, the vessels are often large in size in order to provide sufficient processing/residence time to supply or remove the heat required for the thermal processing processes. The large vessel size in turn requires increases in the vessel wall thickness. Both thick wall construction and large vessel size would increase the capital and operating costs.

It would be desirable to provide an apparatus for thermally processing solid materials and producing thermally processed products having one or more improved features. It would also be desirable to provide a method for thermally processing solid materials and producing thermally processed products having one or more improved features.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

In accordance with a first aspect of the present invention, there is provided an apparatus for thermally processing a solid material to produce thermally processed products, the apparatus comprising:
an inner vessel comprising an inlet for providing the solid material into an interior space defined by walls of the inner vessel, an outlet for removing the thermally processed products produced within the inner vessel, the interior space defining a first pathway between the inlet and the outlet of the inner vessel; and
an outer vessel containing a heat exchange medium in between the inner vessel and the outer vessel, the outer vessel comprising an inlet for providing the heat exchange medium into the outer vessel and an outlet for removing the heat exchange medium from within the outer vessel, a second pathway being defined by the walls of the inner vessel and walls of the outer vessel between the inlet and the outlet of the outer vessel, the inner vessel being configured for at least partial immersion in the heat exchange medium, the first pathway and the second pathway being in heat transfer proximity with each other for heat transfer across the walls of the inner vessel,
wherein the inner vessel is configured for rotation about an axis to enhance the relative movement between the walls of the inner vessel and the heat exchange medium, to enhance the movement of solid particles relative to each other within the inner vessel and relative to the walls of the inner vessel and to pass the solid material and the thermally processed products along the first pathway towards the outlet of the inner vessel, and
wherein the shortest distance from the walls of the inner vessel perpendicularly to the axis about which the inner vessel is rotated changes along a length of the axis to increase surface areas for heat transfer across the walls of the inner vessel.

The apparatus may be positioned such that in use the axis about which the inner vessel is rotated is inclined at an angle of inclination with respect to a ground plane. The angle of inclination may be selected to adjust a rate at which the solid material being thermally processed within the inner vessel is transferred along the first pathway.

The heat exchange medium may comprise a liquid that exerts buoyant forces on the inner vessel.

The heat exchange medium may comprise a pressurised fluid that exerts buoyant forces on the inner vessel. The pressurised fluid may comprise a supercritical fluid.

The amount of heat exchange medium contained in the outer vessel may be controlled such that the buoyant forces exerted by the heat exchange medium on the inner vessel is no bigger than total weight of the inner vessel and the solid material contained therein.

The walls of the inner vessel may be arranged such that the shortest distance from walls of the inner vessel to the axis about which the inner vessel is rotated changes periodically along a length of the rotation axis. In one embodiment, the walls of the inner vessel comprises a plurality of inwardly projecting formations that divide the interior space of the inner vessel into a series of interconnected chambers, the projecting formations being spaced apart at intervals from one another along a length of the inner vessel.

Each projecting formation may extend radially inwardly and may include a first annular wall surface and a second annular wall surface at an acute angle relative to one another, the first and second wall surfaces converging to define an inner radius of the inner vessel. The acute angle may be 45 degrees or less, such as between 1 and 5 degrees or even between 1 and 3 degrees.

A series of annular gaps which narrow radially inwardly may be provided on an exterior of the inner vessel by the acute angle of the first and second annular wall surfaces of the projecting formations.

A plurality of baffles can be attached to the outer vessel which project towards the inner vessel, at least some of the baffles being positioned to align with the annular gaps on the exterior of the inner vessel, the baffles being configured to direct flow of the heat exchange medium into the gaps.

The outer vessel may have a lower section in the shape of a half cylinder and an upper section in the shape of a rectangular cuboid.

The apparatus may further include one or more rollers and/or bearings positioned between the inner vessel and the outer vessel to support the inner vessel for rotation relative to the outer vessel.

The inlet and outlet of the inner vessel may be disposed at opposite ends of the inner vessel.

The inlet of the outer vessel may be disposed at a lower part of the outer vessel and include an inlet manifold for distributing the heat exchange medium along a length of the outer vessel via a plurality of sub-inlets.

The outlet of the outer vessel may be disposed at an upper part of the outer vessel and include an outlet manifold for enabling the heat exchange medium to exit the outer vessel via a plurality of sub-outlets along a length of the outer vessel.

The apparatus may be provided with a grinding medium comprising a plurality of freely moving elements to grind and crush solid material within the rotating inner vessel.

The apparatus may be configured such that peak temperature within the inner vessel is controllable in a range suitable for drying the solid material.

The apparatus may be configured such that peak temperature within the inner vessel is controllable in a range suitable for torrefying the solid material.

The apparatus may also be configured such that peak temperature within the inner vessel is controllable in a range suitable for pyrolysing the solid material.

The solid material may be any one or more of a carbonaceous material: a biomass, a fossil fuel and municipal solid waste.

In one specific embodiment the interior space of the inner vessel is defined by walls, such as two or more walls. Further, the second pathway may be defined by the walls of the inner vessel and walls, such as two or more walls, of the outer vessel between the inlet and the outlet of the outer vessel.

In a second aspect of the invention, there is provided an apparatus for thermally processing a solid material to produce thermally processed products, the apparatus comprising:
an inner vessel comprising an inlet for providing the solid material into an interior space defined by at least one wall of the inner vessel, an outlet for removing the thermally processed products produced within the inner vessel, the interior space defining a first pathway between the inlet and the outlet of the inner vessel; and
an outer vessel containing a heat exchange medium in between the inner vessel and the outer vessel, the outer vessel comprising an inlet for providing the heat exchange medium into the outer vessel and an outlet for removing the heat exchange medium from within the outer vessel, a second pathway being defined by the at least one wall of the inner vessel and at least one wall of the outer vessel between the inlet and the outlet of the outer vessel, the inner vessel being configured for at least partial immersion in the heat exchange medium, the first pathway and the second pathway being in heat transfer proximity with each other for heat transfer across the at least one wall of the inner vessel,
wherein the inner vessel is configured for rotation about an axis to enhance the relative movement between the at least one wall of the inner vessel and the heat exchange medium, to enhance the movement of solid particles relative to each other within the inner vessel and relative to the at least one wall of the inner vessel and to pass the solid material and the thermally processed products along the first pathway towards the outlet of the inner vessel and
wherein the shortest distance from the at least one wall of the inner vessel perpendicularly to the axis about which the inner vessel is rotated changes along a length of the axis to increase surface areas for heat transfer across the at least one wall of the inner vessel.

In a third aspect of the invention, there is provided a method for thermally processing a solid material to produce thermally processed products, the method comprising the steps of:
feeding the solid material into an inner vessel that is rotated about an axis wherein the shortest distance from walls of the inner vessel to the axis about which the inner vessel is rotated changes along a length of the axis;
feeding a heat exchange medium into an outer vessel wherein the inner vessel is at least partly immersed in the heat exchange medium within the outer vessel for the heat exchange medium to exert buoyant forces on the inner vessel while heat exchange takes place between the solid material and the heat exchange medium across the walls of the inner vessel to produce the thermally processed products; and
removing the thermally processed products from the outlet of the inner vessel.

In an embodiment, the walls of the inner vessel comprises a plurality of inwardly projecting formations that divide an interior space of the inner vessel into a series of interconnected chambers, the projecting formations being spaced apart at intervals from one another along a length of the inner vessel.

In one embodiment, the heat exchange medium comprises a liquid or a pressurised fluid to increase the extent of the buoyant forces.

In one specific embodiment, the amount of the heat exchange medium is adjusted so that the sum of the buoyant forces is no bigger than a total weight of the inner vessel and the solid material contained therein.

In a fourth aspect of the invention, there is provided a method for thermally processing a solid material to produce thermally processed products, the method comprising the steps of:
feeding the solid material into an inner vessel that is rotated about an axis wherein the shortest distance from at least one wall of the inner vessel to the axis about which the inner vessel is rotated changes along a length of the axis;
feeding a heat exchange medium into an outer vessel wherein the inner vessel is at least partly immersed in the heat exchange medium within the outer vessel for the heat exchange medium to exert buoyant forces on the inner vessel while heat exchange takes place between the solid material and the heat exchange medium across the at least one wall of the inner vessel to produce the thermally processed products; and
removing the thermally processed products from the outlet of the inner vessel.

Embodiments of the present invention advantageously eliminate the need for an agitator to continuously stir and rotate the solid material. Further, the energy requirements of the apparatus are advantageously reduced by utilising buoyant forces to suspend the inner vessel being rotated. In addition, the rotating vessel immersed in the heat exchange medium creates high relative velocities between the walls of the inner vessel and the heat exchange medium to achieve high heat transfer rates. The rotation of the inner vessel causes the solid material to tumble within the inner vessel to improve the movement of the solid particles relative to each other and relative to the vessel walls (i.e. the heat exchange surface), which in turn improves the heat transfer between the walls of the inner vessel and the solid material to be processed.

Heat transfer involves at least two materials for heat to be transferred from the material at higher temperature to the material at lower temperature. While the description given above was focused on the thermal processing of a solid material to cause physical and/or chemical changes to the solid material, a person skilled in the art will understand that the method and apparatus disclosed above can be used to process a fluid, i.e. causing the required physical and/or chemical changes to the fluid, by using the solid as a heat exchange medium without departing from the scope of the present invention.

### BRIEF DESCRIPTION OF THE DRAWINGS

Notwithstanding any other forms which may fall within the scope of the apparatus and the method as set forth in the Summary, specific embodiments will now be described, by way of examples only, with reference to the accompanying drawings in which:

FIG. 1 is a longitudinal cross-sectional schematic representation of the apparatus in accordance with an embodiment of the invention;

FIG. 2 is a cross-sectional schematic representation of the apparatus illustrated in FIG. 1;

FIG. 3 is a cross-sectional schematic representation of the apparatus having an alternative outer vessel;

FIG. 4 is a longitudinal cross-sectional schematic representation of the apparatus in accordance with another embodiment of the invention; and

FIG. 5 is a longitudinal cross-sectional schematic representation of the apparatus in accordance with another alternative embodiment of the invention.

### DESCRIPTION OF PREFERRED EMBODIMENTS

With reference to the accompanying drawings there is shown an apparatus 10 for thermally processing solid material, for example biomass and/or municipal solid waste to produce thermally processed products. As an example, it will be convenient to describe the invention for use in drying biomass and solid municipal waste. It should however be appreciated that the apparatus is suitable for wider application and use, for example, as an apparatus for torrefaction and pyrolysis of a carbonaceous material.

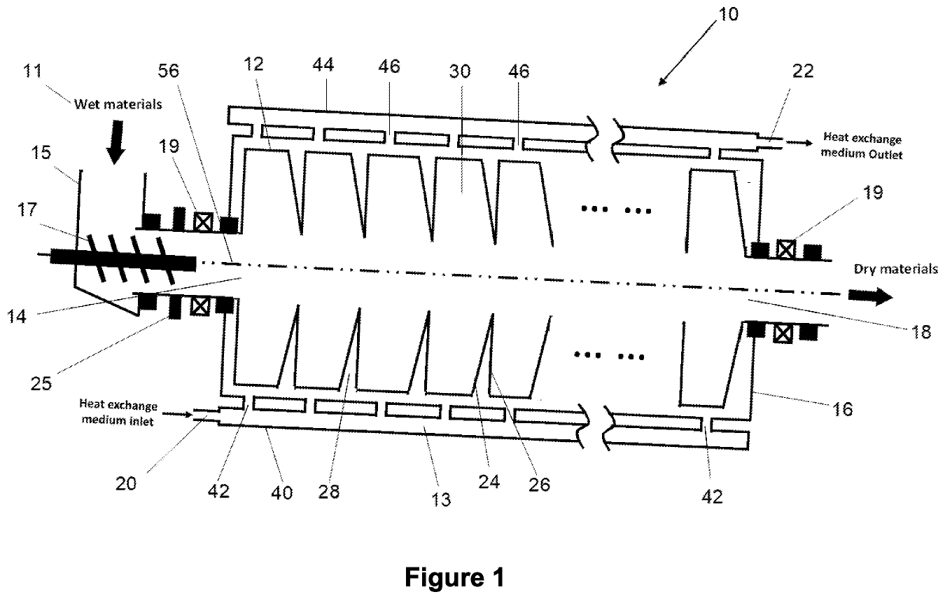

The apparatus 10 includes an inner vessel 12 and an outer vessel 16. The inner vessel 12 is configured to be at least partially submerged in a heat exchange medium 13 contained in the outer vessel 16. The heat exchange medium 13 preferably comprises a liquid, for example thermal oil. It can also comprise a supercritical fluid. As thermal oil is a type of commonly used heat exchange media, the invention will herein be described with reference to this particular medium. The inner vessel 12 includes an inlet 14 for providing a solid material 11, shown as “wet materials” in FIG. 1, into an interior space defined by walls of the inner vessel 12. The heat transfer between the solid material 11 and the heat exchange medium 13 takes place across the walls of the inner vessel 12. The inlet 14 may be equipped with a hopper 15 and a screw feeder 17 that is configured to feed the solid material into the interior of the inner vessel 12. The inner vessel 12 further includes an outlet 18 by which the thermally processed products produced within the inner vessel 12, shown as “dry materials” in FIG. 1, exit. The inlet 14 of the inner vessel 12 is preferably provided at one end of the inner vessel 12 with the outlet 18 being provided at an opposite end. The interior space of the inner vessel 12 between the inlet 14 and the outlet 18 defines a first pathway along which the solid material being processed travels. The apparatus 10 further includes bearings 19 provided at opposite ends of the inner vessel 12 to support the inner vessel 12 for rotation relative to the outer vessel 16.

A motor (not shown in FIG. 1) via a transmission mechanism 25 is used to rotate the inner vessel 12 about an axis 56 (shown as the dotted line in FIG. 1). The walls of the inner vessel 12 are not constructed as a standard cylinder but are constructed in such ways that the shortest distance from the walls of the inner vessel 12 to the axis 56 about which the inner vessel is rotated changes along a length of the axis to increase heat transfer surface areas across the walls of the inner vessel 12.

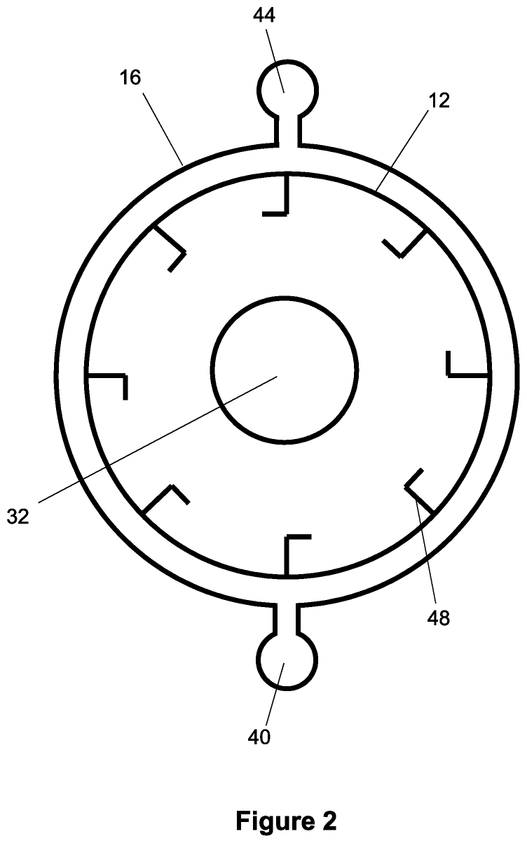

It is obvious that the walls of the inner vessel could take many different shapes. In a preferred embodiment, the walls of the inner vessel 12 comprise a plurality of inwardly projecting formations that divide the interior space of the inner vessel 12 into a series of interconnected chambers 30. The projecting formations are spaced apart at regular intervals from one another, preferably in substantially parallel alignment. The projecting formations may extend radially inwardly and be annulus-like shaped to define a substantially circular passage 32 (FIG. 2) through a central longitudinal axis of the inner vessel 12, which does not have to be but is preferably substantially the same as the axis 56 about which the inner vessel is rotated. The circular passage 32 interconnects the chambers 30 and provides a path for the flow of material progressively through adjacent chambers 30 in the inner vessel 12 from the inlet 14 to the outlet 18. It will however be appreciated that the circular passage 32 may be sized and shaped in various modes.

As best illustrated in FIG. 1, the projecting formations may include a first annular wall surface 24 and the second annual wall surface 26 at an acute angle. The acute angle may be in the range up to 45°, preferably 1° to 10° and even more preferably around 3° relative to one another. The first and second wall surfaces 24, 26 converge to define an inner radius of the inner vessel 12 which is represented by the circular passage 32. On an exterior of the inner vessel 12, the first and second annual wall surfaces 24, 26 result in the creation of a series of annual gaps 28 which narrow radially inwardly. The annular gaps 28 advantageously increase the surface area (heat transfer surface area) of the inner vessel 12 to thereby maximise the ability of the thermal oil to heat transfer across the walls of the inner vessel 12 to the material in the interior space of the inner vessel 12.

In order to further increase the heat transfer surface areas and rates, furthermore, fins or similar structures known to those skilled in the art now or in the future can be added to the sides of the walls of the inner vessel, especially surfaces 24 and 26, that are in contact with the heat exchange medium. The fins also help to improve the turbulence of the heat exchange medium.

The outer vessel 16 includes an inlet 20 for providing the heat exchange medium (e.g. thermal oil) into the outer vessel 16 and an outlet 22 for removing the thermal oil from the outer vessel 16. A second pathway is defined between the inlet 20 and the outlet 22 along which the thermal oil flows to indirectly provide heat for drying, pyrolysis, etc. The inlet 20 for thermal oil is preferably provided at a lower section of the outer vessel 16 and preferably includes an inlet manifold 40 for distributing the thermal oil along a length of the vessel 16 via a plurality of sub-inlets 42. Likewise, the outlet 22 for the thermal oil is disposed at an upper section of the outer vessel 16 in order to ensure that the thermal oil must flow around the inner vessel 12 in order to reach the outlet 22. The outlet 22 includes an outlet manifold 44 which extends the length of the outer vessel 16 and enables the thermal oil to exit via a plurality of sub-outlets 46 along the length of the outer vessel 16.

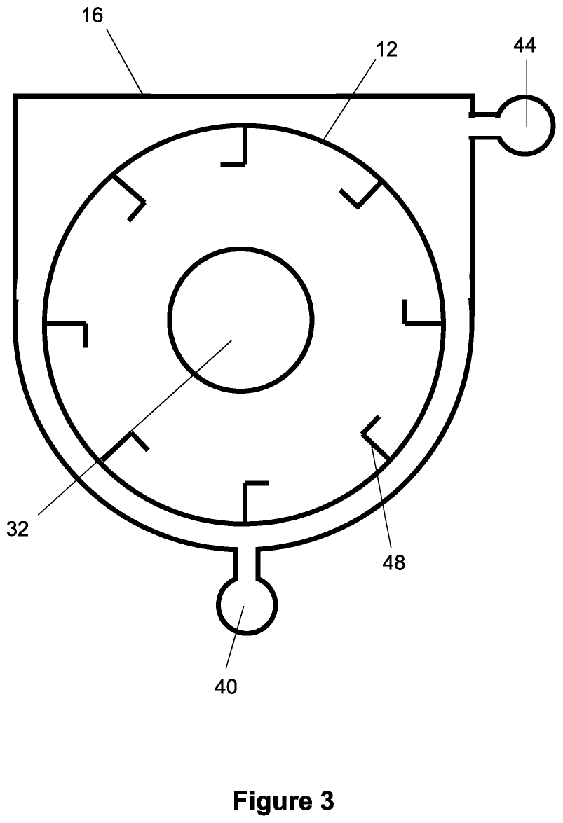

FIG. 3 shows an alternative embodiment with a different shape of the outer vessel 16. The lower section of the outer vessel 16 has the shape of a half cylinder. The upper section of the outer vessel 16 is preferably in the shape of a rectangular cuboid. This advantageously makes it easy for the inner vessel 12 to be positioned down into the outer vessel 16 during assembly.

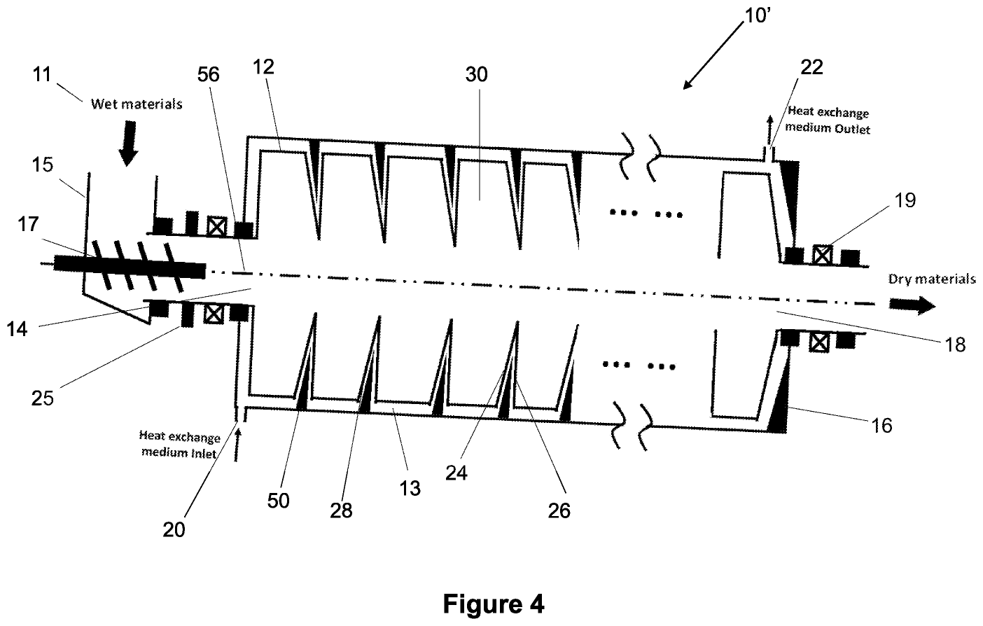

FIG. 4 shows schematically an alternative apparatus 10′ according to another embodiment of the present invention. The same numerals as those in FIG. 1 have been used to denote similar features. The heat exchange medium 13 (e.g. thermal oil) enters the outer vessel 16 from the inlet 20 and exits the outer vessel 16 from the outlet 22, which is positioned at the opposing end of the outer vessel 16. A plurality of baffles 50 are attached to the inner surface of the outer vessel 16. The baffles 50 project towards the inner vessel, at least some of the baffles may be positioned to align with the annular gaps 28 on the exterior of the inner vessel 12. The baffles are designed to increase turbulence by directing the flow of the heat exchange medium into the gaps 28. The heat exchange medium enters each gap 28 by entering the space between its surface 24 and baffle 50 and then flowing through the space between its surface 26 and baffle 50 to exit the gap 28. The heat exchange medium then flows along the narrow annular space between the inner vessel 12 and the outer vessel 16 before it enters the subsequent gap 28. In this arrangement, the heat exchange medium is forced to flow through each gap 28 successively. After passing through the last gap 28, the heat exchange medium exits the outer vessel via the outlet 22.

The amount of thermal oil within the outer vessel 16 depends upon the total weight of the inner vessel 12 and the material to be processed in the inner vessel 12. Preferably the amount of thermal oil inside the outer vessel 16 is controlled such that buoyant and gravity forces generally balance each other out, or balance each other as much as possible, resulting in the bearings 19 supporting minimal weight of the inner vessel 12 and its contents. In one particular example case where the inner vessel is constructed with thin walls, with the inner vessel 12 in place, the thermal oil occupies about 60 to 70% of the capacity of the space between the inner vessel 12 and the outer vessel 16 for the buoyant and gravity forces to balance each other.

Although the chambers 30 illustrated are all of uniform construction, this does not necessarily need to be the case. The chambers 30 could for example become smaller towards the outlet 18 of the inner vessel 12 in order to increase surface area.

As best illustrated in FIGS. 2 and 3, each chamber 30 may also include a series of members 48 which function to mix, scoop and lift material within the inner vessel 12 during rotation. The lifters 48 may take a variety of shapes known to those skilled in the art now and in the future; for example, they may be L-shaped.

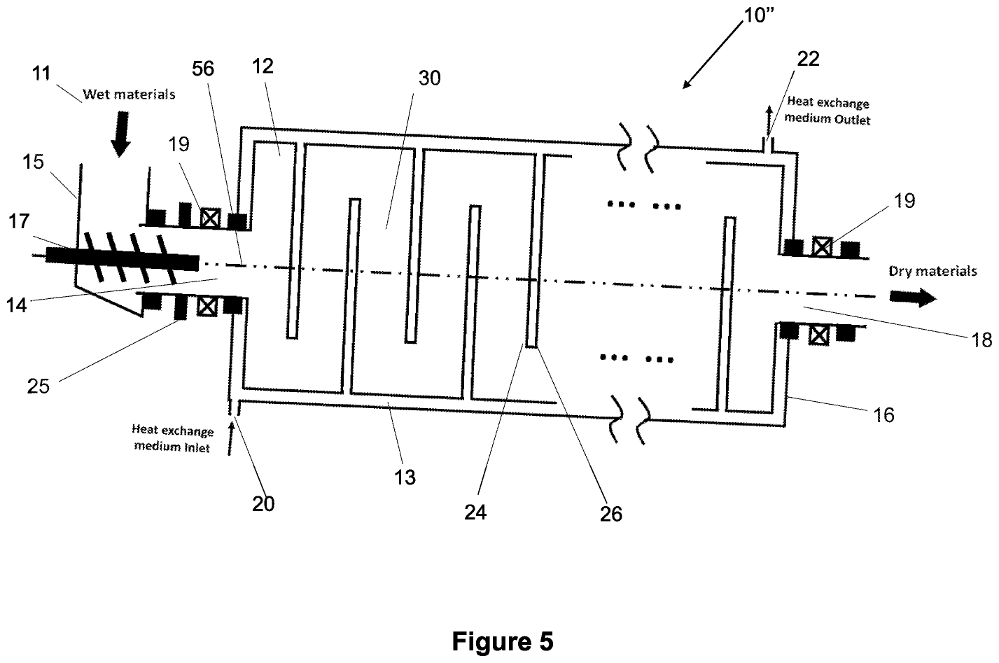

FIG. 5 shows schematically another alternative apparatus 10″ according to another embodiment of the present invention. The same numerals as those in FIG. 1 have been used to denote similar features. The key difference between the apparatus 10″ and the apparatuses 10 and 10′ is that the surfaces 24 and 26 project beyond the axis 56. The chambers 30 in the apparatus 10″ also interconnect differently from those in the apparatuses 10 and 10′.

The apparatuses 10, 10′ or 10″ may also include a variable speed electric motor (not shown) to rotate the inner vessel 12 via the transmission mechanism 25 at a pre-set speed, which may be varied to adjust the turbulence of the heat exchange medium, the turbulence of solid particle movement relative to each other and relative to the walls of the inner vessel and the residence time of the solid in the inner vessel 12.

The apparatuses 10, 10′ or 10″ may be mounted on a skid base frame that can be used for lifting and transportation. Further, the angle of inclination of the inner vessel 12 with respect to horizontal may be varied. Accordingly, the residence time of the solid material and the resulting processed products in the apparatuses 10, 10′ or 10″ may be controlled to allow a sufficient period for the material to be substantially processed at a given temperature.

In further embodiments of the invention, the apparatus may be adapted further to grind or crush material simultaneously with thermally processing the material, as it flows through the inner vessel 12 from the inlet 14 to the outlet 16. In these particular embodiments, the apparatuses 10, 10′ or 10″ may include a grinding medium comprising a plurality of freely movable elements (e.g. hard objects). The freely moving elements may take the form of balls, the balls typically (but not restricted to) having a diameter ranging from about 10 mm to about 120 mm and being made from various hard materials including steel and ceramic. The grinding medium may be mixed with the material before or after the material is introduced to the apparatuses 10, 10′ or 10″ via inlet 14. The grinding medium may be fed into the apparatuses 10, 10′ or 10″ in other means known to those skilled in the art now or in the future. The grinding medium may remain in the inner vessel 12. Rotating the inner vessel 12 imparts momentum to the grinding medium and causes the grinding medium to repeatedly impact the solid material. The grinding medium may also advantageously contribute to mass-heat transfer effects within the inner vessel 12.

Advantageously, when the solid material to be thermally processed, for example a wet pasty solid, can stick to the walls of the inner vessel 12, the use of a grinding medium may effectively remove the solid from the walls of the inner vessel 12.

In use, solid material such as municipal waste or biomass may be introduced to said apparatuses 10, 10′ or 10″ via inlet 14 of the inner vessel 12. The material is progressively transferred through the interconnected chambers 30 of the inner vessel 12 from one end to an opposing end thereof by rotating the inner vessel 12. The lifters 48 within the interconnected chambers 30 assist to the movement of the material within the chambers 30 and into the adjacent chamber 30. In order to further enhance the movement of material along the pathway, the inner vessel 12 may be tilted, for example, between zero and 45°. The angle of inclination with respect to horizontal may also be altered to adjust the rate at which material being thermally processed is transferred along the pathway to the outlet 18. By appropriately selecting the temperature of the thermal oil, the apparatuses 10, 10′ or 10″ may be conveniently used as a dryer, a torrefaction unit or a pyrolysis unit. For example, selecting an operating temperature above 300° C., the apparatuses may be used to produce pyrolysed products; at temperatures between about 200° C. and 280° C., the apparatuses can be used to produce torrefied products; and at reduced operating temperatures between 100° C. and 200° C., the apparatuses can be used as a dryer to evaporate moisture in the material being processed.

Physical and/or chemical changes occur to the heat exchange medium.

Rotating a vessel suspended in a liquid is analogous to a boat sailing through water, which is very energy efficient.

It will be readily apparent to a person skilled in the relevant art that embodiments of the present invention may provide advantages over the prior art including, but not limited to, the following:
providing an apparatus and a method where the vessel with interconnected chambers in which the solid material is thermally processed is suspended in a heat exchange medium while it is rotated, which reduces the energy to rotate the vessel, increases heat transfer surface area, increases the turbulence of the heat exchange medium around the vessel and improves the movement of solid particles relative to each other and relative to the heat exchange surface. These features combine to increase the heat transfer rates within a compact vessel size.
providing a versatile apparatus which can be used as a heating or cooling unit depending upon the heat exchange medium flowing through the outer vessel of the apparatus;
providing an efficient drying apparatus with an increased heat exchange surface area in comparison with prior art drying units to enhance heat exchange rate.

It will be also understood that while the foregoing description refers to specific sequences of process steps, pieces of apparatus and equipment and their configuration are provided for illustrative purposes only and are not intended to limit the scope of the present invention in any way.

In the description of the invention, except where the context requires otherwise due to express language or necessary implication, the words “comprise” or variations such as “comprises” or “comprising” are used in an inclusive sense, i.e. to specify the presence of the stated features, but not to preclude the presence or addition of further features in various embodiments of the invention.

1. An apparatus for thermally processing a solid material to produce thermally processed products, the apparatus comprising:
an inner vessel comprising an inlet for providing the solid material into an interior space defined by walls of the inner vessel, an outlet for removing the thermally processed products produced within the inner vessel, the interior space defining a first pathway between the inlet and the outlet of the inner vessel; and
an outer vessel containing a heat exchange medium in between the inner vessel and the outer vessel, the outer vessel comprising an inlet for providing the heat exchange medium into the outer vessel and an outlet for removing the heat exchange medium from within the outer vessel, a second pathway being defined by the walls of the inner vessel and walls of the outer vessel between the inlet and the outlet of the outer vessel, the inner vessel being configured for at least partial immersion in the heat exchange medium, the first pathway and the second pathway being in heat transfer proximity with each other for heat transfer across the walls of the inner vessel,
wherein the inner vessel is configured for rotation about an axis to enhance the relative movement between the walls of the inner vessel and the heat exchange medium, to enhance the movement of solid particles relative to each other within the inner vessel and relative to the walls of the inner vessel and to pass the solid material and the thermally processed products along the first pathway towards the outlet of the inner vessel,
wherein the shortest distance from the walls of the inner vessel perpendicularly to the axis about which the inner vessel is rotated changes along a length of the axis to increase surface areas for heat transfer across the walls of the inner vessel and
wherein the heat exchange medium comprises a liquid that exerts buoyant forces on the inner vessel.

2. The apparatus according to claim 1, wherein the apparatus is positioned such that in use the axis about which the inner vessel is rotated is inclined at an angle of inclination with respect to a ground plane to adjust a rate at which the solid material being thermally processed within the inner vessel is transferred along the first pathway.

3-4. (canceled)

5. The apparatus according to claim 1, wherein an amount of the heat exchange medium contained in the outer vessel is controlled such that the buoyant forces exerted by the heat exchange medium on the inner vessel is no bigger than a total weight of the inner vessel and the solid material contained therein.

6. The apparatus according to claim 1, wherein the walls of the inner vessel are arranged such that the shortest distance from the walls of the inner vessel to the axis about which the inner vessel is rotated changes periodically along a length of the axis about which the inner vessel is rotated.

7. The apparatus according to claim 1, wherein the walls of the inner vessel comprise a plurality of inwardly projecting formations that divide the interior space of the inner vessel into a series of interconnected chambers, the projecting formations being spaced apart at intervals from one another along a length of the inner vessel.

8. The apparatus according to claim 7, wherein each projecting formation extends radially inwardly and includes a first annular wall surface and a second annular wall surface at an acute angle relative to one another, the first and second wall surfaces converging to define an inner radius of the inner vessel.

9. The apparatus according to claim 8, wherein the acute angle is between about 1 and 20 degrees.

10. The apparatus according to claim 8, wherein a series of annular gaps which narrow radially inwardly are provided on an exterior of the inner vessel by the acute angle of the first and second annular wall surfaces of the projecting formations.

11. The apparatus according to claim 10, wherein a plurality of baffles are attached to the outer vessel which project towards the inner vessel, at least some of the baffles being positioned to align with the annular gaps on the exterior of the inner vessel, the baffles being configured to direct flow of the heat exchange medium into the gaps.

12. The apparatus according to claim 1, wherein the outer vessel has a lower section in the shape of a half cylinder and an upper section in the shape of a rectangular cuboid.

13. The apparatus according to claim 1, further including one or more rollers and/or bearings positioned between the inner vessel and the outer vessel to support the inner vessel for rotation relative to the outer vessel.

14. The apparatus according to claim 1, wherein the inlet and the outlet of the inner vessel are disposed at opposite ends of the inner vessel.

15-16. (canceled)

17. The apparatus according to claim 1, wherein the apparatus is provided with a grinding medium comprising a plurality of freely moving elements to grind and crush solid material within the inner vessel.

18. The apparatus according to claim 1, wherein the apparatus is configured such that peak temperature within the inner vessel is controllable in a range suitable for drying the solid material.

19. (canceled)

20. The apparatus according to claim 1, wherein the apparatus is configured such that peak temperature within the inner vessel is controllable in a range suitable for pyrolysing the solid material.

21. The apparatus according to claim 1, wherein the solid material is any one or more of a carbonaceous material: a biomass, a fossil fuel and municipal solid waste.

22. (canceled)

23. An apparatus for thermally processing a solid material to produce thermally processed products, the apparatus comprising:
an inner vessel comprising an inlet for providing the solid material into an interior space defined by at least one wall of the inner vessel, an outlet for removing the thermally processed products produced within the inner vessel, the interior space defining a first pathway between the inlet and the outlet of the inner vessel; and
an outer vessel containing a heat exchange medium in between the inner vessel and the outer vessel, the outer vessel comprising an inlet for providing the heat exchange medium into the outer vessel and an outlet for removing the heat exchange medium from within the outer vessel, a second pathway being defined by the at least one wall of the inner vessel and at least one wall of the outer vessel between the inlet and the outlet of the outer vessel, the inner vessel being configured for at least partial immersion in the heat exchange medium, the first pathway and the second pathway being in heat transfer proximity with each other for heat transfer across the at least one wall of the inner vessel,
wherein the inner vessel is configured for rotation about an axis to enhance the relative movement between the at least one wall of the inner vessel and the heat exchange medium, to enhance the movement of solid particles relative to each other within the inner vessel and relative to the at least one wall of the inner vessel and to pass the solid material and the thermally processed products along the first pathway towards the outlet of the inner vessel,
wherein the shortest distance from the at least one wall of the inner vessel perpendicularly to the axis about which the inner vessel is rotated changes along a length of the axis to increase surface areas for heat transfer across the at least one wall of the inner vessel and
wherein the heat exchange medium comprises a liquid or a pressurized fluid to increase extents of the buoyant forces.

24. A method for thermally processing a solid material to produce thermally processed products, the method comprising the steps of:
feeding the solid material into an inner vessel that is rotated about an axis wherein the shortest distance from walls of the inner vessel to the axis about which the inner vessel is rotated changes along a length of the axis;
feeding a heat exchange medium into an outer vessel wherein the inner vessel is at least partly immersed in the heat exchange medium within the outer vessel for the heat exchange medium to exert buoyant forces on the inner vessel while heat exchange takes place between the solid material and the heat exchange medium across the walls of the inner vessel to produce the thermally processed products; and
removing the thermally processed products from the outlet of the inner vessel,
wherein the heat exchange medium comprises a liquid or a pressurised fluid to increase extents of the buoyant forces.

25. The method according to claim 24, wherein the walls of the inner vessel comprise a plurality of inwardly projecting formations that divide an interior space of the inner vessel into a series of interconnected chambers, the projecting formations being spaced apart at intervals from one another along a length of the inner vessel.

26. (canceled)

27. The method according to claim 24, wherein an amount of the heat exchange medium is adjusted so that a sum of the buoyant forces is no bigger than total weight of the inner vessel and the solid material contained therein.

28. (canceled)
